(19) United States
(12) Patent Application Publication
(10) Pub. No.: US 2024/0365428 A1
(43) Pub. Date: Oct. 31, 2024

(54) DRX CONFIGURATION METHOD, TERMINAL, NETWORK ELEMENT DEVICE, AND MEDIUM

(71) Applicant: GUANGDONG OPPO MOBILE TELECOMMUNICATIONS CORP., LTD., Dongguan (CN)

(72) Inventors: Zhe FU, Dongguan (CN); Shukun WANG, Dongguan (CN)

(21) Appl. No.: 18/765,615

(22) Filed: Jul. 8, 2024

Related U.S. Application Data
(63) Continuation of application No. PCT/CN2022/071389, filed on Jan. 11, 2022.

(51) Int. Cl. H04W 76/28; H04L 1/1812; H04W 80/02

(52) U.S. Cl. CPC H04W 76/28; H04L 1/1812; H04W 80/02

(57) ABSTRACT

Provided is a discontinuous reception (DRX) configuration method. The method includes: receiving a specific DRX configuration, wherein the specific DRX configuration corresponds to a parameter configuration with a non-integer cycle. Wherein receiving the specific DRX configuration includes: receiving a plurality of sets of DRX configurations, wherein the plurality of sets of DRX configurations include the specific DRX configuration.

### CROSS-REFERENCE TO RELATED APPLICATION

This application is a continuation application of International Application No. PCT/CN2022/071389, filed on Jan. 11, 2022, the entire contents of which are incorporated herein by reference.

### TECHNICAL FIELD

The present disclosure relates to the field of mobile communications, in particular to a discontinuous reception (DRX) configuration method, an apparatus, a device, and a medium.

### BACKGROUND

The third generation partnership project (3GPP) supports various vertical industries more and more widely and deeply. For example, the 3GPP supports extended reality (XR) services. The XR services support service transmissions in augmented reality (AR), virtual reality (VR), and cloud gaming.

Features of the XR services include: non-integer cycle; time jitter; and large and variable data packet size.

### SUMMARY

Embodiments of the present disclosure provide a DRX configuration method, an apparatus, a device, and a medium. The technical solutions are as follows.

According to some embodiments of the present disclosure, a DRX configuration method is provided. The method includes: receiving a specific DRX configuration, wherein the specific DRX configuration corresponds to a parameter configuration with a non-integer cycle.

According to some embodiments of the present disclosure, a DRX configuration method is provided. The method includes: transmitting a specific DRX configuration, wherein the specific DRX configuration corresponds to a parameter configuration with a non-integer cycle.

According to some embodiments of the present disclosure, a DRX configuration apparatus is provided. The apparatus includes: a receiving module, configured to receive a specific DRX configuration, wherein the specific DRX configuration corresponds to a parameter configuration with a non-integer cycle.

According to some embodiments of the present disclosure, a DRX configuration apparatus is provided. The apparatus includes: a transmitting module, configured to transmit a specific DRX configuration, wherein the specific DRX configuration corresponds to a parameter configuration with a non-integer cycle.

According to some embodiments of the present disclosure, a terminal is provided. The terminal includes: a processor and a memory storing one or more computer programs therein, wherein the processor, when loading and running the one or more computer programs, is caused to perform the DRX configuration method as described above.

According to some embodiments of the present disclosure, a network element device is provided. The network element device includes: a processor and a memory storing one or more computer programs therein, wherein the processor, when loading and running the one or more computer programs, is caused to perform the DRX configuration method as described above.

According to some embodiments of the present disclosure, a non-transitory computer-readable storage medium storing one or more computer programs therein is provided, wherein the one or more computer programs, when loaded and run by a processor, cause the processor to perform the DRX configuration method as described above.

According to some embodiments of the present disclosure, a computer program product including one or more computer instructions therein is provided. The one or more computer instructions are stored in a computer-readable storage medium, and when loaded and executed by a processor of a computer device, cause the computer device to perform the DRX configuration method as described above.

According to some embodiments of the present disclosure, a chip is provided. The chip is configured to perform the DRX configuration method as described above.

### BRIEF DESCRIPTION OF DRAWINGS

For clearer description of the technical solutions in the embodiments of the present disclosure, the following briefly describes the accompanying drawings required for describing the embodiments. Apparently, the accompanying drawings in the following description show merely some embodiments of the present disclosure, and those of ordinary skill in the art may still derive other drawings from these accompanying drawings without any creative efforts.

FIG. 1 is a block diagram of a communication system according to some embodiments of the present disclosure;

FIG. 2 is a block diagram of a communication system according to some embodiments of the present disclosure;

FIG. 3 is a flowchart of a DRX configuration method according to some embodiments of the present disclosure;

FIG. 4 is a flowchart of a DRX configuration method according to some embodiments of the present disclosure;

FIG. 5 is a schematic diagram of a message header format of a medium access control (MAC) control element (CE) according to some embodiments of the present disclosure;

FIG. 6 is a flowchart of a DRX configuration method according to some embodiments of the present disclosure;

FIG. 7 is a flowchart of a DRX configuration method according to some embodiments of the present disclosure;

FIG. 8 is a flowchart of a DRX configuration method according to some embodiments of the present disclosure;

FIG. 9 is a block diagram of a DRX configuration apparatus according to some embodiments of the present disclosure;

FIG. 10 is a block diagram of a DRX configuration apparatus according to some embodiments of the present disclosure; and

FIG. 11 is a block diagram of a communication device according to some embodiments of the present disclosure.

### DETAILED DESCRIPTION

Exemplary embodiments are described in detail herein, and examples are shown in the accompany drawings. Unless otherwise indicated, the same numbers in different accompany drawings indicate the same or similar elements in the following description relates to the accompanying drawings. The embodiments described in the following exemplary embodiments do not represent all embodiments consistent with the present disclosure, and are merely examples of devices and methods that are consistent with aspects of the present disclosure detailed in the attached claims.

It should be understood that the term “several” herein means one or more, and the term “a plurality of” means two or more. The term “and/or” describes associations between associated objects, and indicates three types of relationships. For example, the phrase “A and/or B” means A, B, or, both A and B. The character “/” generally indicates that the associated objects are in an “or” relationship.

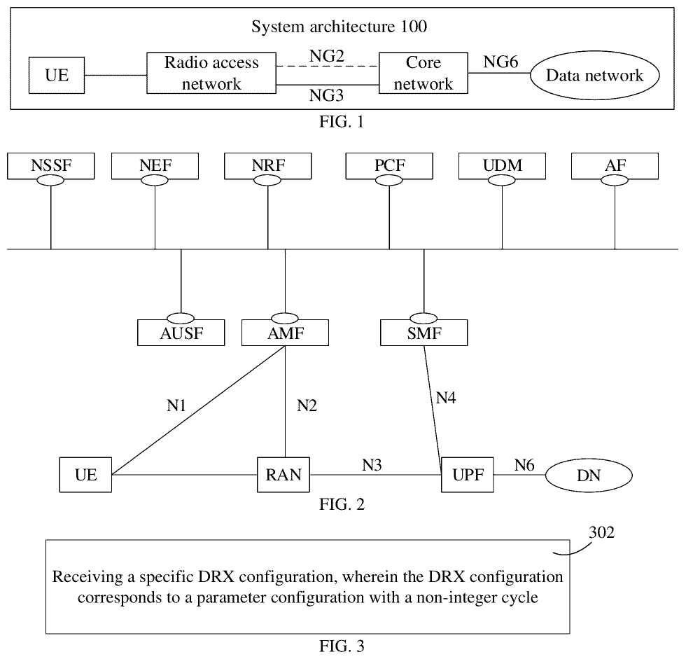

FIG. 1 is a schematic diagram of an of a communication system according to some embodiments of the present disclosure. As shown in FIG. 1, the system architecture 100 includes a UE, a radio access network (RAN), a core network (CN), and a data network (DN). The UE, the RAN, and the CN are mainly elements of the architecture, and are logically arranged into two portions of a use side and a control side. The control side manages a mobile network, and the user side transmits service data. In FIG. 1, an NG2 reference point is located between a RAN control side and a CN control side, an NG3 reference point is located between a RAN user side and a CN user side, and an NG6 reference point is located between the CN user side and the DN.

The UE is an access of interaction of a mobile user and the network, and is capable of providing essential computing capability and storing capability, displaying a service window to the user, and receiving operation input of the user. The UE establishes signal connection and data connection with the RAN by the next generation air interface technology, and hence transmits control signals and service data to the mobile network.

The RAN is similar to a station in a conventional network, is deployed close to the UE, provides a network access function for authorized users within a coverage range of a cell, and transmits user data based on levels of the users, requirements of services, and the like over transmission channels with different qualities. The RAN is capable of managing and reasonably using its own resources, providing access services for the UE on demand, and forwarding the control signals and the user data between the UE and the CN.

The CN maintains subscription data of the mobile network, manages network elements of the mobile network, and provides session management, mobility management, policy management, security authentication, and other functions to the UE. In the case that the UE is attached, the CN provides a network access authentication for the UE. In the case that the UE initiates a service request, the CN allocates network resources to the UE. In the case that the UE moves, the CN updates network resources for the UE. In the case that the UE is idle, the CN provides a quick resumption mechanism for the UE. In the case that the UE is unattached, the CN releases the network resources for the UE when UE is unattached. In the case that the UE has service data, the CN provides data routing functions to the UE, for example, a function of forwarding uplink data to the DN, or receiving UE downlink data from the DN, forwarding the UE downlink data to the RAN, and transmitting the UE downlink data to the UE.

The DN is a data network for providing the service data to the users. Generally, a client is disposed in the UE, and a server end is disposed in the data network. The data network is a private network (for example, a local area network), an external network not controlled by the carrier (for example, the Internet), or a proprietary network jointly deployed by the carriers (for example, for configuring an Internet Protocol (IP) multimedia core network subsystem (IMS) service).

FIG. 2 is a detailed architecture determined based on FIG. 1 and includes a plurality of detailed network functions (NFs). The NF is referred to as a network function entity, a network entity, a function entity, or a network element. Illustratively, the CN user side includes a user plane function (UPF), and the CN control side includes an authentication server function (AUSF), an access and mobility management function (AMF), a session management function (SMF), a network slice selection function (NSSF), a network exposure function (NEF), a network repository function (NRF), a unified data management (UDM), a policy control function (PCF), and an application function (AF). The functions of the function entities are as follows: the UPF indicates forwarding the user data packet based on routing rules of the SMF; the AUSF indicates performing the security authentication of the UE; the AMF indicates the access and the mobility management; the SMF indicates the session management; the NSSF indicates selecting the network slice for the UE; the NEF indicates opening the network function for a third party in an API interface mode; the NRF indicates providing storage function and selection function of the network function entity information to other network elements; the UDM indicates that the user subscripts context management; the PCF indicates user policy management; and the AF indicates user application management.

In the architecture shown in FIG. 2, an N1 interface is a reference point between the UE and the AMF, an N2 interface is a reference point between the RAN and the AMF for transmitting the NAS message and the like, an N3 interface is a reference point between the RAN and the UPF for transmitting data in the user side and the like, an N4 interface is a reference point between the SMF and the UPF for transmitting channel (for example, connected to the N3 interface) identify information, data cache indication information, downlink data notification information, and other information, and an N6 interface is a reference point between the UPF and the DN for transmitting the data on the user side and the like. The NG interface is an interface between the RAN and the 5G CN.

It should be noted that names of the interfaces between various network elements in FIG. 1 and FIG. 2 are exemplary, and the names of the interfaces may be otherwise defined in specific implementations, which are not specifically limited in the embodiments of the present disclosure. The various network elements (for example, the SMF, the AF, the UPF, and the like) in FIG. 1 and FIG. 2 are also exemplarily named, and the names of the network elements do not limit the functions thereof. In the 5GS and other future networks, the network elements may have other names, which are not specifically limited in the embodiments of the present disclosure. For example, in the 6G network, some or all of the network elements follow the terms in the 5G in terms of naming, or have other names, or the like, which are unified herein and are not described hereinafter. In addition, it should be understood that names of messages (or signaling) transmitted between the network elements are also exemplary, and do not limit the functions of the messages.

FIG. 3 is a flowchart of a DRX configuration method according to some embodiments of the present disclosure. The embodiments of the present disclosure are illustrated by taking the method being applicable to the above terminal as an example. The method includes the following processes.

In S302, a specific DRX configuration is received, wherein the DRX configuration corresponds to a parameter configuration with a non-integer cycle.

The specific DRX configuration is also referred to as a first DRX configuration, a DRX configuration with a non-integer cycle, or a DRX configuration of the XR service, and the name of the specific DRX configuration is not limited in the embodiments.

In some embodiments, the specific DRX configuration is a DRX configuration supporting the XR service. The specific DRX configuration includes a set of DRX configurations or a series of associated DRX configurations.

The specific DRX configuration corresponds to a time jitter parameter configuration.

In some embodiments, the specific DRX configuration includes at least one of the following parameters:
a DRX on duration timer (drx-onDurationTimer);
a DRX inactivity timer (drx-InactivityTimer);
a downlink DRX round-trip delay timer (drx-HARQ-RTT-TimerDL);
an uplink DRX round-trip delay timer (drx-HARQ-RTT-TimerUL);
a downlink DRX retransmission timer (drx-RetransmissionTimerDL);
an uplink DRX retransmission timer (drx-RetransmissionTimerUL);
a long DRX cycle;
a short DRX cycle;
a long DRX cycle offset; or
a short DRX cycle offset.

In some embodiments, an index of the specific DRX configuration is unique in a same DRX group, or an index of the specific DRX configuration is unique for a same terminal.

In summary, in the method according to the embodiments, for the requirements of the XR service, a network configuration is configured for the specific DRX configuration for the XR service. In the case that the network configuration includes a plurality of sets of DRX configurations, and the XR service and other services coexist, the XR service uses the specific DRX configuration, other services use conventional DRX configurations, and DRXs of different services are unbound, such that refined DRX control is achieved, and the energy saving of the UE is further facilitated.

A scenario where the specific DRX configuration is used for a DRX group or an index of a DRX configuration:

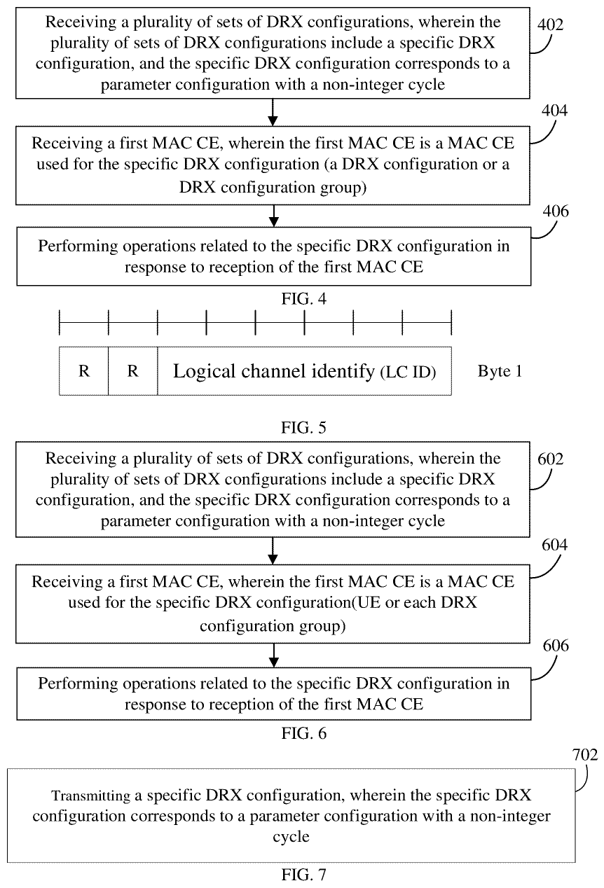

FIG. 4 is a flowchart of a DRX configuration method according to some embodiments of the present disclosure. The embodiments of the present disclosure are illustrated by taking the method being applicable to the terminal as an example. The method includes the following processes.

In S402, a plurality of sets of DRX configurations are received, wherein the plurality of sets of DRX configurations include the specific DRX configuration, and the specific DRX configuration corresponds to a parameter configuration with a non-integer cycle.

The specific DRX configuration is also referred to as a first DRX configuration, a DRX configuration with a non-integer cycle, or a DRX configuration of the XR service, and the name of the specific DRX configuration is not limited in the embodiments.

In some embodiments, the plurality of sets of DRX configurations include indication information of the specific DRX configuration. The indication information indicates one or more of the plurality of sets of DRX configurations corresponding to the parameter configuration with the non-integer cycle. Illustratively, the non-integer cycle is 6.67 ms.

In some embodiments, the plurality of sets of DRX configurations include type information of each of the plurality of sets of DRX configurations. The type information includes an integer cycle type or a non-integer cycle type. For example, a first set of DRX configurations is in the integer cycle type, and a second set of DRX configurations is in the non-integer cycle type.

In some embodiments, the specific DRX configuration includes a set of DRX configurations or a series of associated DRX configurations. Other DRX configurations than the specific DRX configuration in the plurality of sets of DRX configurations correspond to the parameter configurations with the integer cycle.

For example, the terminal receives three sets of DRX configurations: DRX-config, DRX-config-secondarygroup, and DRX-config-XR. The DRX-config and DRX-config-secondarygroup correspond to the DRX configurations with the integer cycle, and the DRX-config-XR corresponds to the DRX configuration with the non-integer cycle.

For example, the terminal receives four sets of DRX configurations: DRX-config, DRX-config-secondarygroup, DRX-config-XR-FR1, and DRX-config-XR-FR2. The DRX-config and DRX-config-secondarygroup correspond to the DRX configurations with the integer cycle, and the DRX-config-XR-FR1 and DRX-config-XR-FR2 correspond to the DRX configurations with the non-integer cycle. The DRX-config-XR-FR1 corresponds to the FR1 frequency band, and the DRX-config-XR-FR2 corresponds to the FR2 frequency band. The frequency range FR1 is a frequency range generally referred to as a 5G sub-6 GHz (below 6 GHz) frequency band, and the frequency range FR2 is a 5G millimeter wave frequency band.

In some embodiments, the specific DRX configuration corresponds to a time jitter parameter configuration. In the case that the specific DRX configuration includes one set of DRX configurations, the set of DRX configurations corresponds to the time jitter parameter configuration. In the case that the specific DRX configuration includes a series of associated DRX configurations, the series of associated DRX configurations corresponds to the time jitter parameter configuration.

For example, the network configures a plurality of different offset positions and/or offset use rules for the terminal by a radio resource control (RRC) message.

Furthermore, other DRX configurations than the specific DRX configuration in the plurality of sets of DRX configurations correspond to non-jitter parameter configurations. That is, a frequency of the network indicating a change of the offset by the RRC message, a downlink control information (DCI), or the like is reduced.

In some embodiments, the plurality of sets of DRX configurations belong to a same DRX group. That is, the plurality of sets of DRX configurations are based on the DRX group configurations (per DRX group configuration). For example, the plurality of sets of DRX configurations are configured in the DRX-config or the DRX-config-secondarygroup in the above embodiments.

In some embodiments, the plurality of sets of DRX configurations belong to different DRX groups. That is, the plurality of sets of DRX configurations are in different DRX groups.

In some embodiments, an index of the DRX configuration is unique in a same DRX group, and the index of the DRX configuration is also referred to as an identify of the DRX configuration or a DRX identify. Different DRX configurations differ by DRX group identifies and the indexes of the DRX configurations. That is, the index of the DRX configuration is unique in the same DRX group, and may be not unique in different DRX groups.

In some embodiments, the index of the DRX configuration is unique in the same UE.

Different DRX configurations differ by the indexes of the DRX configurations.

In some embodiments, each of the plurality of sets of DRX configurations includes at least one of the following parameters:
a drx-onDurationTimer;
a drx-InactivityTimer;
a drx-HARQ-RTT-TimerDL;
a drx-HARQ-RTT-TimerUL;
a drx-RetransmissionTimerDL;
a drx-RetransmissionTimerUL;
a long DRX cycle;
a short DRX cycle;
a long DRX cycle offset; or
a short DRX cycle offset.

In S404, a first medium access control (MAC) control element (CE) is received, wherein the first MAC CE is a MAC CE used for the specific DRX configuration.

The first MAC CE is the MAC CE used for the specific DRX configuration.

In the embodiments of the present disclosure, the first MAC CE is a MAC CE used for the specific DRX configuration corresponding to an index of a DRX configuration, or a MAC CE used for the specific DRX configuration in a DRX group.

In some embodiments, the first MAC CE is also referred to as a first DRX command MAC CE or a first long DRX command MAC CE.

The specific DRX configuration corresponds to the parameter configuration with the non-integer cycle. In some embodiments, the specific DRX configuration includes a set of DRX configurations or a series of associated DRX configurations.

In some embodiments, the first MAC CE includes at least one of the following pieces of information:
a logical channel (LC) identify (ID) of the first MAC CE, wherein the LC ID represents a control command of the MAC CE for the specific DRX configuration;
a DRX group ID, for example, the DRX group ID is an ID of a DRX group of the specific DRX configuration;
a DRX configuration index, for example, the DRX configuration index is an ID or an index of the specific DRX configuration, and is also referred to as a DRX ID; or
a DRX type ID, wherein the DRX type ID includes an integer cycle type or a non-integer cycle type, and the DRX type ID of the specific DRX configuration is the non-integer cycle type.

In some embodiments, the first MAC CE carries the DRX group ID, the DRX configuration index, the DRX type ID, or the LC ID of the first MAC CE.

A MAC CE is determined as the first MAC CE in the case that the MAC CE is for a specific DRX group, the MAC CE is for a specific DRX type, or the MAC CE is for a specific DRX group ID and an index of the DRX configuration is unique in a MAC entity or a UE (the DRX is uniquely distinguished by the index of the DRX configuration, the DRX group is uniquely distinguished by the DRX group, or the DRX type is uniquely distinguished by the DRX type).

In some embodiments, the first MAC CE carries a group unique ID and the DRX group ID. The group unique ID is the index of the DRX configuration, the DRX type ID, or the DRX group ID. That is, the specific DRX configuration is uniquely identified by the DRX group ID and the group unique ID.

The above DRX-related IDs (at least one of the DRX group ID, the index of the DRX configuration, or the DRX type ID) are carried in a payload of the first MAC CE or an R-field of a MAC header of the first MAC CE.

In the case that the above DRX-related IDs are carried in the payload, the above DRX-related IDs require LC IDs different from conventional DRX commands, that is, new LC IDs.

In the case that the above DRX-related IDs are carried in the R-field, the above DRX-related IDs are represented by different bits. For example, 00 represents all DRX, 01 represents the specific DRX configuration (XR DRX), 10 represents MBS DRX, and 11 represents the conventional DRX commands. In this case, the LC ID of the MAC CE is an LC ID of the conventional DRX command or an LC ID different from the LC ID of the conventional DRX command.

The header format of the first MAC CE is shown in FIG. 5. The header is one byte (Oct), that is, eight bits. The first two bits are the R-field, and the last six bits are the LC ID.

In S406, operations related to the specific DRX configuration are performed in response to reception of the first MAC CE.

In some embodiments, the terminal stops a timer for the specific DRX configuration in response to receiving the first MAC CE. In some embodiments, the timer is the drx-onDurationTimer and/or the drx-InactivityTimer.

In some embodiments, the terminal stops a short DRX cycle timer (drx-ShortCycleTimer) for the specific DRX configuration and/or uses a long DRX cycle for the specific DRX configuration in response to receiving the first MAC CE and the first MAC CE being a first long DRX command MAC CE.

In some embodiments, the terminal uses a short DRX cycle for the specific DRX configuration and/or starts a short DRX cycle timer for the specific DRX configuration in response to receiving the first MAC CE and the short DRX cycle being configured.

In some embodiments, the terminal uses a long DRX cycle for the specific DRX configuration and/or starts a long DRX cycle timer for the specific DRX configuration in response to receiving the first MAC CE and the long DRX cycle being configured.

In summary, in the method according to the embodiments, for the requirements of the XR service, a network configuration is configured for the specific DRX configuration for the XR service. In the case that the network configuration includes a plurality of sets of DRX configurations, and the XR service and other services coexist, the XR service uses the specific DRX configuration, other services use conventional DRX configurations, and DRXs of different services are unbound, such that refined DRX control is achieved, and the energy saving of the UE is further facilitated.

A scenario where the specific DRX configuration is used for a UE or each DRX group:

FIG. 6 is a flowchart of a DRX configuration method according to some embodiments of the present disclosure. The embodiments of the present disclosure are illustrated by taking the method being applicable to the terminal as an example. The method includes the following processes.

In S602, a plurality of sets of DRX configurations are received, wherein the plurality of sets of DRX configurations include the specific DRX configuration, and the specific DRX configuration corresponds to a parameter configuration with a non-integer cycle.

The specific DRX configuration is also referred to as a first DRX configuration, a DRX configuration with the non-integer cycle, or a DRX configuration of the XR service, and the name of the specific DRX configuration is not limited in the embodiments.

In some embodiments, the plurality of sets of DRX configurations include indication information of the specific DRX configuration. The indication information indicates one or more of the plurality of sets of DRX configurations corresponding to the parameter configuration with the non-integer cycle. Illustratively, the non-integer cycle is 6.67 ms.

In some embodiments, the plurality of sets of DRX configurations include type information of each of the plurality of sets of DRX configurations. The type information includes an integer cycle type or a non-integer cycle type. For example, a first set of DRX configurations is in the integer cycle type, and a second set of DRX configurations is in the non-integer cycle type.

In some embodiments, the specific DRX configuration includes a set of DRX configurations or a series of associated DRX configurations. Other DRX configurations than the specific DRX configuration in the plurality of sets of DRX configurations correspond to the parameter configurations with the integer cycle.

For example, the terminal receives three sets of DRX configurations: DRX-config, DRX-config-secondarygroup, and DRX-config-XR. The DRX-config and DRX-config-secondarygroup correspond to the DRX configurations with the integer cycle, and the DRX-config-XR corresponds to the DRX configuration with the non-integer cycle.

For example, the terminal receives four sets of DRX configurations: DRX-config, DRX-config-secondarygroup, DRX-config-XR-FR1, and DRX-config-XR-FR2. The DRX-config and DRX-config-secondarygroup correspond to the DRX configurations with the integer cycle, and the DRX-config-XR-FR1 and DRX-config-XR-FR2 correspond to the DRX configurations with the non-integer cycle. The DRX-config-XR-FR1 corresponds to the FR1 frequency band, and the DRX-config-XR-FR2 corresponds to the FR2 frequency band. The frequency range FR1 is a frequency range generally referred to as a 5G sub-6 GHz (below 6 GHz) frequency band, and the frequency range FR2 is a 5G millimeter wave frequency band.

In some embodiments, the specific DRX configuration corresponds to a time jitter parameter configuration. In the case that the specific DRX configuration includes a set of DRX configurations, the set of DRX configurations corresponds to the time jitter parameter configuration. In the case that the specific DRX configuration includes a series of associated DRX configurations, the series of associated DRX configurations corresponds to the time jitter parameter configuration.

For example, the network configures a plurality of different offset positions and/or offset use rules for the terminal by an RRC message.

Furthermore, other DRX configurations than the specific DRX configuration in the plurality of sets of DRX configurations correspond to non-jitter parameter configurations. That is, a frequency of the network indicating a change of the offset by the RRC message, a DCI, or the like is reduced.

In some embodiments, the plurality of sets of DRX configurations belong to a same DRX group. That is, the plurality of sets of DRX configurations are based on the DRX group configurations (per DRX group configuration). For example, the plurality of sets of DRX configurations are configured in the DRX-config or the DRX-config-secondarygroup in the above embodiments.

In some embodiments, the plurality of sets of DRX configurations belong to different DRX groups. That is, the plurality of sets of DRX configurations are in different DRX groups.

In some embodiments, an index of the DRX configuration is unique in a same DRX group, and the index of the DRX configuration is also referred to as an identify of the DRX configuration or a DRX identify. Different DRX configurations differ by DRX group identifies and the indexes of the DRX configurations. That is, the index of the DRX configuration is unique in the same DRX group, and may be not unique in different DRX groups.

In some embodiments, the index of the DRX configuration is unique in the same UE.

Different DRX configurations differ by the indexes of the DRX configurations.

In some embodiments, each of the plurality of sets of DRX configurations includes at least one of the following parameters:
a drx-onDurationTimer;
a drx-InactivityTimer;
a drx-HARQ-RTT-TimerDL;
a drx-HARQ-RTT-TimerUL;
a drx-RetransmissionTimerDL;
a drx-RetransmissionTimerUL;
a long DRX cycle;
a short DRX cycle;
a long DRX cycle offset; or
a short DRX cycle offset.

In S604, a first MAC CE is received, wherein the first MAC CE is a MAC CE used for the specific DRX configuration.

The first MAC CE is the MAC CE used for the specific DRX configuration.

In the embodiments of the present disclosure, the first MAC CE is a MAC CE used for the specific DRX configuration in the terminal, or a MAC CE used for the specific DRX configuration in each DRX group.

In some embodiments, the first MAC CE is also referred to as a first DRX command MAC CE or a first long DRX command MAC CE.

In some embodiments, the first MAC CE includes at least one of the following pieces of information:
an LC ID of the first MAC CE, wherein the LC ID represents a control command of the MAC CE for the specific DRX configuration;
a DRX group ID, wherein the DRX group ID is an ID of a DRX group of the specific DRX configuration;
a DRX configuration index, wherein the DRX configuration index is an ID of the DRX configuration; or
a DRX type ID, wherein the DRX type ID includes an integer cycle type or a non-integer cycle type, and the DRX type ID of the specific DRX configuration is the non-integer cycle type.

In some embodiments, the first MAC CE carries the DRX group ID, the DRX configuration index, the DRX type ID, or the LC ID of the first MAC CE.

In some embodiments, in the case that the DRX configuration index, the DRX group ID, or the DRX type ID is unique in the UE, the first MAC CE functions on the specific DRX configuration.

In some embodiments, in the case that the DRX configuration index, the DRX group ID, or the DRX type ID is unique in a non-UE, for example, a DRX group not indicated, the first MAC CE functions on DRX configurations corresponding to the index in all DRX groups (that is, as long as the DRX configuration type or the DRX configuration index is the same, the corresponding operation is performed regardless of the DRX group).

The above DRX-related IDs (at least one of the DRX group ID, the index of the DRX configuration, or the DRX type ID) are carried in a payload of the first MAC CE or an R-field of a MAC header of the first MAC CE.

In the case that the above DRX-related IDs are carried in the payload, the above DRX-related IDs require LC IDs different from conventional DRX commands, that is, new LC IDs.

In the case that the above DRX-related IDs are carried in the R-field, the above DRX-related IDs are represented by different bits. For example, 00 represents all DRX, 01 represents the specific DRX configuration (XR DRX), 10 represents MBS DRX, and 11 represents the conventional DRX commands. In this case, the LC ID of the MAC CE is an LC ID of the conventional DRX command or an LC ID different from the LC ID of the conventional DRX command.

The header format of the first MAC CE is shown in FIG. 5. The header is one byte (Oct), that is, eight bits. The two front bits are R-field, and the rear six bits are the LC ID.

The specific DRX configuration corresponds to the parameter configuration with the non-integer cycle. In some embodiments, the specific DRX configuration includes a set of DRX configurations or a series of associated DRX configurations.

In S606, operations related to the specific DRX configuration of a terminal are performed in response to reception of the first MAC CE.

In some embodiments, the terminal stops the timer for the specific DRX configuration of the terminal in response to the first MAC CE. In some embodiments, the timer is the drx-onDurationTimer and/or the drx-InactivityTimer.

In some embodiments, the terminal stops a short DRX cycle timer (drx-ShortCycleTimer) for the specific DRX configuration of the terminal and/or uses a long DRX cycle for the specific DRX configuration of the terminal in response to receiving the first MAC CE and the first MAC CE being a first long DRX command MAC CE.

In some embodiments, the terminal uses a short DRX cycle for the specific DRX configuration of the terminal and/or starts a short DRX cycle timer for the specific DRX configuration of the terminal in response to receiving the first MAC CE and the short DRX cycle being configured.

In some embodiments, the terminal uses a long DRX cycle for the specific DRX configuration of the terminal and/or starts a long DRX cycle timer for the specific DRX configuration of the terminal in response to receiving the first MAC CE and the long DRX cycle being configured.

In summary, in the method according to the embodiments, for the requirements of the XR service, a network configuration is configured for the specific DRX configuration for the XR service. In the case that the network configuration includes a plurality of sets of DRX configurations, and the XR service and other services coexist, the XR service uses the specific DRX configuration, other services use conventional DRX configurations, and DRXs of different services are unbound, such that refined DRX control is achieved, and the energy saving of the UE is further facilitated.

FIG. 7 is a flowchart of a DRX configuration method according to some embodiments of the present disclosure. The embodiments of the present disclosure are illustrated by taking the method being applicable to a network device as an example. The method includes the following processes.

In S702, a specific DRX configuration is transmitted, wherein the specific DRX configuration corresponds to a parameter configuration with a non-integer cycle.

The specific DRX configuration is also referred to as a first DRX configuration, a DRX configuration with the non-integer cycle, or a DRX configuration of the XR service, and the name of the specific DRX configuration is not limited in the embodiments.

In some embodiments, the specific DRX configuration is a configuration supporting the XR service. The specific DRX configuration includes a set of DRX configurations or a series of associated DRX configurations.

The specific DRX configuration corresponds to a time jitter parameter configuration.

In some embodiments, the specific DRX configuration includes at least one of the following parameters:
a drx-onDurationTimer;
a drx-InactivityTimer;
a drx-HARQ-RTT-TimerDL;
a drx-HARQ-RTT-TimerUL;
a drx-RetransmissionTimerDL;
a drx-RetransmissionTimerUL;
a long DRX cycle;
a short DRX cycle;
a long DRX cycle offset; or
a short DRX cycle offset.

In some embodiments, an index of the specific DRX configuration is unique in a same DRX group, or an index of the specific DRX configuration is unique for a same terminal.

In summary, in the method according to the embodiments, for the requirements of the XR service, a network configuration is configured for the specific DRX configuration for the XR service. In the case that the network configuration includes a plurality of sets of DRX configurations, and the XR service and other services coexist, the XR service uses the specific DRX configuration, other services use conventional DRX configurations, and DRXs of different services are unbound, such that refined DRX control is achieved, and the energy saving of the UE is further facilitated.

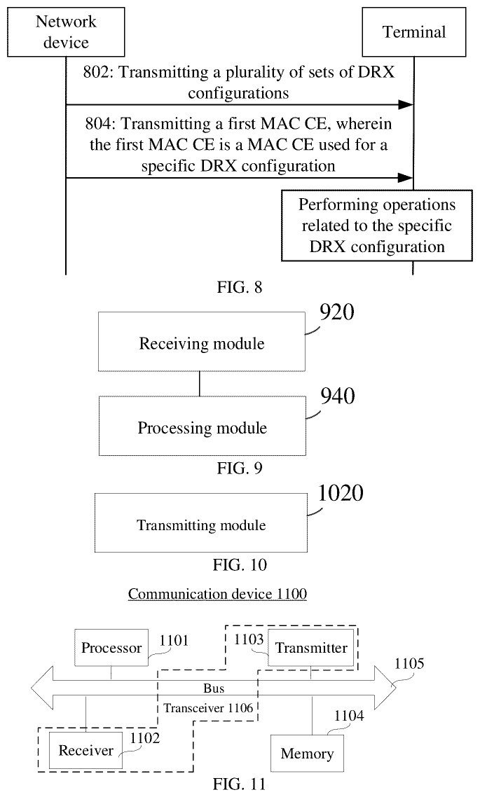

FIG. 8 is a flowchart of a DRX configuration method according to some embodiments of the present disclosure. The embodiments of the present disclosure are illustrated by taking the method being applicable to the network device as an example. The method includes the following processes.

In S802, a plurality of sets of DRX configurations are transmitted, wherein the plurality of series of DRX configurations include the specific DRX configuration, and the specific DRX configuration corresponds to a parameter configuration with a non-integer cycle.

The specific DRX configuration is also referred to as a first DRX configuration, a DRX configuration with a non-integer cycle, or a DRX configuration of the XR service, and the name of the specific DRX configuration is not limited in the embodiments.

In some embodiments, the plurality of sets of DRX configurations include indication information of the specific DRX configuration. The indication information indicates one or more of the plurality of sets of DRX configurations corresponding to the parameter configuration with the non-integer cycle. Illustratively, the non-integer cycle is 6.67 ms.

In some embodiments, the plurality of sets of DRX configurations include type information of each of the plurality of sets of DRX configurations. The type information includes an integer cycle type or a non-integer cycle type. For example, a first set of DRX configurations is in the integer cycle type, and a second set of DRX configurations is in the non-integer cycle type.

In some embodiments, the specific DRX configuration includes a set of DRX configurations or a series of associated DRX configurations. Other DRX configurations than the specific DRX configuration in the plurality of sets of DRX configurations correspond to the parameter configurations with the integer cycle.

For example, the terminal receives three sets of DRX configurations: DRX-config, DRX-config-secondarygroup, and DRX-config-XR. The DRX-config and DRX-config-secondarygroup correspond to the DRX configurations with the integer cycle, and the DRX-config-XR corresponds to the DRX configuration with the non-integer cycle.

For example, the terminal receives four sets of DRX configurations: DRX-config, DRX-config-secondarygroup, DRX-config-XR-FR1, and DRX-config-XR-FR2. The DRX-config and DRX-config-secondarygroup correspond to the DRX configurations with the integer cycle, and the DRX-config-XR-FR1 and DRX-config-XR-FR2 correspond to the DRX configurations with the non-integer cycle. The DRX-config-XR-FR1 corresponds to the FR1 frequency band, and the DRX-config-XR-FR2 corresponds to the FR2 frequency band. The frequency range FR1 is a frequency range generally referred to as a 5G sub-6 GHz (below 6 GHz) frequency band, and the frequency range FR2 is a 5G millimeter wave frequency band.

In some embodiments, the specific DRX configuration corresponds to a time jitter parameter configuration. In the case that the specific DRX configuration includes one set of DRX configurations, the set of DRX configurations corresponds to the time jitter parameter configuration. In the case that the specific DRX configuration includes a series of associated DRX configurations, the series of associated DRX configurations corresponds to the time jitter parameter configuration.

For example, the network configures a plurality of different offset positions and/or offset use rules for the terminal by an RRC message.

Furthermore, other DRX configurations than the specific DRX configuration in the plurality of sets of DRX configurations correspond to non-jitter parameter configurations. That is, a frequency of the network indicating a change of the offset by the RRC message, a DCI, or the like is reduced.

In some embodiments, the plurality of sets of DRX configurations belong to a same DRX group. That is, the plurality of sets of DRX configurations are based on the DRX group configurations (per DRX group configuration). For example, the plurality of sets of DRX configurations are configured in the DRX-config or the DRX-config-secondarygroup in the above embodiments.

In some embodiments, the plurality of sets of DRX configurations belong to different DRX groups. That is, the plurality of sets of DRX configurations are in different DRX groups.

In some embodiments, an index of the DRX configuration is unique in a same DRX group, and the index of the DRX configuration is also referred to as an identify of the DRX configuration or a DRX identify. Different DRX configurations differ by DRX group identifies and the indexes of the DRX configurations. That is, the index of the DRX configuration is unique in the same DRX group, and may be not unique in different DRX groups.

In some embodiments, the index of the DRX configuration is unique in the same UE. Different DRX configurations differ by the indexes of the DRX configurations.

In some embodiments, each of the plurality of sets of DRX configurations includes at least one of the following parameters:
a drx-onDurationTimer;
a drx-InactivityTimer;
a drx-HARQ-RTT-TimerDL;
a drx-HARQ-RTT-TimerUL;
a drx-RetransmissionTimerDL;
a drx-RetransmissionTimerUL;
a long DRX cycle;
a short DRX cycle;
a long DRX cycle offset; or
a short DRX cycle offset.

In S804, a first MAC CE is transmitted, wherein the first MAC CE is a MAC CE used for the specific DRX configuration.

The first MAC CE is the MAC CE used for the specific DRX configuration.

In some embodiments, the first MAC CE is a MAC CE used for the specific DRX configuration corresponding to an index of a DRX configuration, or a MAC CE used for the specific DRX configuration in a DRX group.

In some embodiments, the first MAC CE is a MAC CE used for the specific DRX configuration in the terminal, or a MAC CE used for the specific DRX configuration in each DRX group.

In some embodiments, the first MAC CE is also referred to as a first DRX command MAC CE or a first long DRX command MAC CE.

The specific DRX configuration corresponds to the parameter configuration with the non-integer cycle. In some embodiments, the specific DRX configuration includes a set of DRX configurations or a series of associated DRX configurations.

In some embodiments, the first MAC CE includes at least one of the following pieces of information:
an LC ID of the first MAC CE, wherein the LC ID represents a control command of the MAC CE for the specific DRX configuration;
a DRX group ID, for example, the DRX group ID is an ID of a DRX group of the specific DRX configuration;
a DRX configuration index, for example, the DRX configuration index is an ID or an index of the specific DRX configuration, and is also referred to as a DRX ID; or
a DRX type ID, wherein the DRX type ID includes an integer cycle type or a non-integer cycle type, and the DRX type ID of the specific DRX configuration is the non-integer cycle type.

In some embodiments that the first MAC CE is for the DRX configuration or the DRX configuration group, the first MAC CE carries the DRX group ID, the DRX configuration index, the DRX type ID, or the LC ID of the first MAC CE.

A MAC CE is determined as the first MAC CE in the case that the MAC CE is for a specific DRX group, the MAC CE is for a specific DRX type, or the MAC CE is for a specific DRX group ID and an index of the DRX configuration is unique in a MAC entity or a UE (the DRX is uniquely distinguished by the index of the DRX configuration, the DRX group is uniquely distinguished by the DRX group, or the DRX type is uniquely distinguished by the DRX type).

In some embodiments that the first MAC CE is for the DRX configuration or the DRX configuration group, the first MAC CE carries a group unique ID and the DRX group ID. The group unique ID is the index of the DRX configuration, the DRX type ID, or the DRX group ID. That is, the specific DRX configuration is uniquely identified by the DRX group ID and the group unique ID.

In some embodiments that the first MAC CE is for the UE or each DRX configuration group, the first MAC CE carries the DRX group ID, the DRX configuration index, the DRX type ID, or the LC ID of the first MAC CE.

In some embodiments, in the case that the DRX configuration index, the DRX group ID, or the DRX type ID is unique in the UE, the first MAC CE functions on the specific DRX configuration.

In some embodiments, in the case that the DRX configuration index, the DRX group ID, or the DRX type ID is unique in a non-UE, for example, a DRX group not indicated, the first MAC CE functions on DRX configurations corresponding to the index in all DRX groups (that is, as long as the DRX configuration type or the DRX configuration index is the same, the corresponding operation is performed regardless of the DRX group).

The above DRX-related IDs (at least one of the DRX group ID, the index of the DRX configuration, or the DRX type ID) are carried in a payload of the first MAC CE or an R-field of a MAC header of the first MAC CE.

In the case that the above DRX-related IDs are carried in the payload, the above DRX-related IDs require LC IDs different from conventional DRX commands, that is, new LC IDs.

In the case that the above DRX-related IDs are carried in the R-field, the above DRX-related IDs are represented by different bits. For example, 00 represents all DRX, 01 represents the specific DRX configuration (XR DRX), 10 represents MBS DRX, and 11 represents the conventional DRX commands. In this case, the LC ID of the MAC CE is an LC ID of the conventional DRX command or an LC ID different from the LC ID of the conventional DRX command.

The above methods can be divided and combined to acquire new embodiments in various ways according to understanding of those skilled in the art, which are not repeated in detail in the present disclosure.

An R17 version of the 3rd Generation Partnership Project (3GPP) proposes to support enhancement of a survival time (ST) for ultra-reliable and low latency communications (URLLC). The current ST is defined as follows:
the ST and time sensitive communication auxiliary information (TSCAI) are transmitted to the station together;
the ST is a specified by the AF in units of “time” with the timescale corresponding to burst periodicity or as the maximum number of consecutive message transmission failures where a message is a single burst including a single packet/frame or an aggregated set of packets/frames and a transmission failure occurs when the Packet Delay Budget requirement corresponding to the message is not satisfied

That is, for an application or a service, in the case that the ST is characterized by a cycle of the service, and the ST is equal to the cycle, a next packet transmission must be correct if a current packet transmission fails; otherwise, the communication service transmission fails.

The ST may be supported on an unlicensed band and a licensed band. The licensed band supports the following method for triggering entry into the ST: retransmission and determination based on a configured scheduling radio-network temporary identifier (CS-RNTI) scheduling. However, whether to enhance the ST for the unlicensed band requires to be described.

A reference mechanism of the ST supports that “a CG source is used for services having the ST such that a mapping relationship between the services and the retransmission grant is well known to the gNB and the UE, and CG retransmission scheduling (performed by the CS-RNTI) is used for triggering an ST state.”
A. It is urgent to discuss how the UE identifies a data radio bear (DRB) that shall enter the ST state, and other details.
B. It is urgent to discuss whether to enhance the ST for the unlicensed band.

The embodiments of the present disclosure provide a method for entering the ST state based on hybrid automatic repeat request-negative acknowledgement (HARQ-NACK), which is applicable to the unlicensed band. The method is performed by the terminal.

For the DRB supporting the ST, in determining whether the DRB is the HARQ-NACK, determining whether the HARQ-NACK is a consecutive HARQ-NACK, determining whether to enter the ST (state), determining whether to perform packet data convergence protocol duplication (PDCP duplication) activation, or determining whether transmission of the packet fails, at least one of the following conditions is considered:
1. retransmission scheduling or a retransmission grant of the CS-RNTI scheduling is received;
2. downlink feedback information-NACK (DFI-NACK) signaling is received;
3. CG retransmission timer (CGRT) is expired; and in some embodiments, for the expired CGRT, the CG Timer (CGT) is in an expired state, or the CGT is running;
4. newly reported uplink scheduling or DFI-NACK signaling is not received by the CGRT upon expiration of the CGRT; in some embodiments, in this case, for the expired CGRT, the CGT is expiring, or the CGT is running;
5. a MAC PDU is assembled, but is not transmitted or fails to be transmitted due to an uplink listen before talk (UL LBT) failure; or
6. a MAC PDU is assembled or an uplink grant is available, but a LBT failure indication is received from a bottom layer.

That is, whether the DRB is the HARQ-NACK, whether the HARQ-NACK is a consecutive HARQ-NACK, whether to enter the ST (state), whether to perform PDCP duplication activation, or whether transmission of the packet fails is determined in at least one of the above six cases.

In some embodiments, the above conditions are for the DRB/logical channel (LCH)/HARQ correspondingly supporting the ST; and/or a HARQ process used in the DRB/LCH/HARQ correspondingly supporting the ST, and/or a CG or CG group used in the DRB/LCH/HARQ correspondingly supporting the ST, and/or DRB/LCH/HARQ correspondingly supporting the ST; and/or a MAC entity used in the DRB/LCH/HARQ correspondingly supporting the ST; and/or a carrier used in the DRB/LCH/HARQ correspondingly supporting the ST.

In some embodiments, in the case that the DRB/LCH/HARQ is configured with ST support or use, whether the DRB/LCH/HARQ is the HARQ-NACK, whether the HARQ-NACK is a consecutive HARQ-NACK, whether to enter the ST (state), whether to perform PDCP duplication activation, or whether transmission of the packet fails is determined by counting the HARQ-ACK and/or based on maintenance of a transmit (TX) side timer. In some embodiments, the determining method is based on at least one of the above methods. In some embodiments, the method is applicable to the licensed band and the unlicensed band.

In some embodiments, in the case that the DRB/LCH/HARQ is configured with ST support or use, the terminal determines the ST state of the DRB/LCH/HARQ, or the terminal determines whether to trigger the DRB/LCH/HARQ to enter the ST state. In some embodiments, the terminal is the MAC layer of the terminal. In some embodiments, the method is applicable to the licensed band and the unlicensed band.

In some embodiments, in the case that the DRB/LCH/HARQ is configured with ST support or use, and the DRB/LCH/HARQ is not in the ST state, the terminal determines the ST state of the DRB/LCH/HARQ, or the terminal determines whether to trigger the DRB/LCH/HARQ to enter the ST state. In some embodiments, the terminal may be the MAC layer of the terminal. That is, detection/determination is not supported or performed in the case that the DRB/LCH/HARQ enters the ST state, or the detection/determination is performed in the case that the DRB/LCH/HARQ exits the ST state. In some embodiments, the method is applicable to the licensed band and the unlicensed band.

In some embodiments, in the case that the DRB/LCH/HARQ is configured with ST support or use, exiting the ST state is determined by at least one of the following conditions:
the ST timer is expired;
the network indicates exiting the ST state;
the network indicates that PDCP duplication is deactivated, or PDCP duplication fails to enter the state prior to the ST;
the CGT is expired;
a HARQ-ACK indication or DFI-ACK indication is received prior to expiration of the CGRT;
the HARQ-ACK indication or DFI-ACK indication is received; or
furthermore, for example, in the ST state or prior to expiration of the ST timer, the HARQ-ACK indication or DFI-ACK indication is received, wherein the indication is for the ST state.

In some embodiments, the ST state is for at least one of: the DRB/LCH/HARQ correspondingly supporting the ST; and/or a HARQ process used in the DRB/LCH/HARQ correspondingly supporting the ST, and/or a CG or CG group used in the DRB/LCH/HARQ correspondingly supporting the ST, and/or DRB/LCH/HARQ correspondingly supporting the ST; and/or a MAC entity used in the DRB/LCH/HARQ correspondingly supporting the ST; and/or a carrier used in the DRB/LCH/HARQ correspondingly supporting the ST. In some embodiments, the method is applicable to the licensed band and the unlicensed band.

In some embodiments, in the case that the DRB/LCH/HARQ is configured with ST support or use, the terminal determines the ST state of the DRB/LCH/HARQ, or the terminal determines whether to trigger the DRB/LCH/HARQ to enter the ST state. In some embodiments, the terminal may be the MAC layer of the terminal. In some embodiments, the method is applicable to the licensed band and the unlicensed band.

In some embodiments, in the case that the DRB/LCH/HARQ is configured with ST support or use, counting of the HARQ-ACK and/or maintenance of the transmit (TX) side timer is for the DRB/LCH/HARQ correspondingly supporting the ST; and/or a HARQ process used in the DRB/LCH/HARQ correspondingly supporting the ST, and/or a CG or CG group used in the DRB/LCH/HARQ correspondingly supporting the ST, and/or DRB/LCH/HARQ correspondingly supporting the ST, and/or a MAC entity used in the DRB/LCH/HARQ correspondingly supporting the ST, and/or a carrier used in the DRB/LCH/HARQ correspondingly supporting the ST. In some embodiments, the method is applicable to the licensed band and the unlicensed band.

The “DRB/LCH/HARQ” indicates a “DRB or LCH or HARQ” process.

In some embodiments, an implementation of combining the counting of the HARQ-ACK and the transmit (TX) side timer.
1) In S1, the network configures ST-related parameters for the DRB.

For example, the ST-related parameters include a TX side timer and a ST enabler. For simpleness, the network configures a 1:1 mapping for the DRB a specific CG, and the specific CG is associated with a HARQ process.
2) In S2, the MAC layer of the terminal determines to trigger the ST state of the DRB in the case that the DRB is not in the ST state. That is, the detection/determination is not supported in the case that the DRB enters the ST state, or the detection/determination is performed in the case that the DRB exits the ST state. S2 is simultaneously applicable to the licensed band and the unlicensed band.

Specifically,
ST_COUNTER is a new variable for calculating consecutive HARQ-NACKs, and is initially set as 0 for the corresponding HARQ process or DRB;
the TX side timer is started or restarted for the corresponding HARQ or DRB process in the case that the initial transmission of a packet of the DRB is performed;
the ST_COUNTER of the corresponding HARQ process or DRB is plus 1 in the case that the TX side timer is running and receives the retransmission grant of the corresponding HARQ process or DRB;
the ST_COUNTER of the corresponding HARQ process or DRB is reset as 0 in the case that the TX side timer is running and receives the transmission grant of the corresponding HARQ process or DRB;
the ST_COUNTER of the corresponding HARQ process or DRB is reset as 0 and the upper layer is instructed to activate the PDCP duplication in the case that the ST_COUNTER is equal to N prior to expiration of the TX side timer; and
the ST_COUNTER of the corresponding HARQ process or DRB is reset as 0 in the case that the ST_COUNTER is less than N upon expiration of the TX side timer.
3) In S3, the PDCP of the terminal activates the PDCP duplication in response to PDCP duplication activation indication from the lower layer.

For the embodiments, in some embodiments, the DBR is replaced with the LCH.

For the embodiments, in some embodiments, the method is applicable to the licensed band and the unlicensed band.

In the R17 URLLC conflict resolution project, RAN1 supports the following conclusions regarding A/N feedback of semi-persistent scheduling (SPS).

Deferral of SPS HARQ-ACK dropped due to time-division duplex (TDD) specific collision until a next available physical uplink control channel (PUCCH) is supported based on semi-persistent configuration of a slot format.

The DRX mechanism of the corresponding RAN2 is to be updated, that is, the drx-HARQ-RTT-TimerDL is started in the case that the UE is in the HARQ-ACK delay, such that the UE is in the on duration state in the DRX cycle, monitors a physical downlink control channel (PDCCH), and acquires K1. The K1 is used to carry parameters of PUCCH resources of the HARQ-ACK.

The embodiments of the present disclosure further provide a HARQ-ACK delay method or a method for starting a timer. When DRX is configured, the MAC entity shall:
1. in the case that a MAC PDU is received in a configured downlink assignment: start the drx-HARQ-RTT-TimerDL for the corresponding HARQ process in the first symbol after the end of the corresponding transmission carrying the DL HARQ feedback; and stop the drx-RetransmissionTimerDL for the corresponding HARQ process; and
2. in the case that the HARQ-ACK is subject to HARQ-ACK deferral as specified in TS 38.213: start the drx-RetransmissionTimerDL in the first symbol upon the configured downlink assignment for the corresponding HARQ process.

FIG. 9 is a block diagram of a DRX configuration apparatus according to some embodiments of the present disclosure. The apparatus is practiced as all or part of the terminal, or applicable to the terminal. The apparatus includes:
a receiving module 920, configured to receive a specific DRX configuration, wherein the specific DRX configuration corresponds to a parameter configuration with a non-integer cycle.

In some embodiments, the specific DRX configuration includes a set of DRX configurations or a series of associated DRX configurations.

In some embodiments, the specific DRX configuration corresponds to a time jitter parameter configuration.

In some embodiments, an index of the specific DRX configuration is unique in a same DRX group, or an index of the specific DRX configuration is unique for a same terminal.

In some embodiments, the receiving module 920 is configured to receive a plurality of sets of DRX configurations, wherein the plurality of sets of DRX configurations include the specific DRX configuration.

In some embodiments, the plurality of sets of DRX configurations include: indication information of the specific DRX configuration; or type information of each of the plurality of sets of DRX configurations, wherein the type information includes an integer cycle type or a non-integer cycle type.

In some embodiments, the plurality of sets of DRX configurations belong to a same DRX group or different DRX groups.

In some embodiments, each of the plurality of sets of DRX configurations includes at least one of the following parameters:
a drx-onDurationTimer;
a drx-InactivityTimer;
a drx-HARQ-RTT-TimerDL;
a drx-HARQ-RTT-TimerUL;
a drx-RetransmissionTimerDL;
a drx-RetransmissionTimerUL;
a long DRX cycle;
a short DRX cycle;
a long DRX cycle offset; or
a short DRX cycle offset.

In some embodiments, the receiving module 920 is further configured to receive a first MAC CE, wherein the first MAC CE is a MAC CE used for the specific DRX configuration.

In some embodiments, the first MAC CE is a MAC CE used for the specific DRX configuration corresponding to an index of a DRX configuration, or a MAC CE used for the specific DRX configuration in a DRX group.

In some embodiments, the first MAC CE is a MAC CE used for the specific DRX configuration in a terminal, or a MAC CE used for the specific DRX configuration in each DRX group.

In some embodiments, the apparatus further includes:
a processing module 940, configured to stop a timer for the specific DRX configuration in response to receiving the first MAC CE.

In some embodiments, the processing module 940 is configured to stop a short DRX cycle timer for the specific DRX configuration and/or use a long DRX cycle for the specific DRX configuration in response to receiving the first MAC CE and the first MAC CE being a first long DRX command MAC CE.

In some embodiments, the processing module 940 is configured to use a short DRX cycle for the specific DRX configuration and/or start a short DRX cycle timer for the specific DRX configuration in response to receiving the first MAC CE and the short DRX cycle being configured.

In some embodiments, the processing module 940 is configured to use a long DRX cycle for the specific DRX configuration and/or start a long DRX cycle timer for the specific DRX configuration in response to receiving the first MAC CE and the long DRX cycle being configured.

In some embodiments, the first MAC CE includes at least one of the following pieces of information:
an LC ID of the first MAC CE;
a DRX group ID;
a DRX configuration index; or
a DRX type ID.

FIG. 10 is a block diagram of a DRX configuration apparatus according to some embodiments of the present disclosure. The apparatus is practiced as all or part of the terminal, or applicable to the terminal. The apparatus includes:
a transmitting module 1020, configured to transmit a specific DRX configuration, wherein the specific DRX configuration corresponds to a parameter configuration with a non-integer cycle.

In some embodiments, the specific DRX configuration includes a set of DRX configurations or a series of associated DRX configurations.

In some embodiments, the specific DRX configuration corresponds to a time jitter parameter configuration.

In some embodiments, an index of the specific DRX configuration is unique in a same DRX group, or an index of the specific DRX configuration is unique for a same terminal.

In some embodiments, the transmitting module 1020 is configured to transmit a plurality of sets of DRX configurations, wherein the plurality of sets of DRX configurations include the specific DRX configuration.

In some embodiments, the plurality of sets of DRX configurations include: indication information of the specific DRX configuration; or type information of each of the plurality of sets of DRX configuration, wherein the type information includes an integer cycle type or a non-integer cycle type.

In some embodiments, the plurality of sets of DRX configurations belong to a same DRX group or different DRX groups.

In some embodiments, each of the plurality of sets of DRX configurations includes at least one of the following parameters:
a drx-onDurationTimer;
a drx-InactivityTimer;
a drx-HARQ-RTT-TimerDL;
a drx-HARQ-RTT-TimerUL;
a drx-RetransmissionTimerDL;
a drx-RetransmissionTimerUL;
a long DRX cycle;
a short DRX cycle;
a long DRX cycle offset; or
a short DRX cycle offset.

In some embodiments, the transmitting module 1020 is further configured to transmit a first MAC CE, wherein the first MAC CE is a MAC CE used for the specific DRX configuration.

In some embodiments, the first MAC CE is a MAC CE used for the specific DRX configuration corresponding to an index of a DRX configuration, or a MAC CE used for the specific DRX configuration in a DRX group.

In some embodiments, the first MAC CE is a MAC CE used for the specific DRX configuration in a terminal, or a MAC CE used for the specific DRX configuration in each DRX group.

The embodiments of the present disclosure further provide an apparatus for entering ST state based on HARQ-NACK, which is applicable to the unlicensed band. The apparatus is practiced as all or part of the terminal, or applicable to the terminal. The apparatus includes a processing module.

For the DRB supporting the ST, in determining whether the DRB is the HARQ-NACK, determining whether the HARQ-NACK is a consecutive HARQ-NACK, determining whether to enter the ST (state), determining whether to perform packet data convergence protocol duplication (PDCP duplication) activation, or determining whether transmission of the packet fails, the processing module is configured to determine whether at least one of the following conditions is satisfied:
1. retransmission scheduling or a retransmission grant of the CS-RNTI scheduling is received;
2. downlink feedback information-NACK (DFI-NACK) signaling is received;
3. CGRT is expired; and in some embodiments, for the expired CGRT, the CG Timer (CGT) is in an expired state, or the CGT is running;
4. newly reported uplink scheduling or DFI-NACK signaling is not received by the CGRT upon expiration of the CGRT; in some embodiments, in this case, for the expired CGRT, the CGT is expiring, or the CGT is running;
5. a MAC PDU is assembled, but is not transmitted or fails to be transmitted due to an uplink listen before talk (UL LBT) failure; or
6. a MAC PDU is assembled or an uplink grant is available, but a LBT failure indication is received from a bottom layer.

That is, whether the DRB is the HARQ-NACK, whether the HARQ-NACK is a consecutive HARQ-NACK, whether to enter the ST (state), whether to perform PDCP duplication activation, or whether transmission of the packet fails is determined in at least one of the above six cases.

In some embodiments, the above conditions are for the DRB/logical channel (LCH)/HARQ correspondingly supporting the ST; and/or a HARQ process used in the DRB/LCH/HARQ correspondingly supporting the ST, and/or a CG or CG group used in the DRB/LCH/HARQ correspondingly supporting the ST, and/or DRB/LCH/HARQ correspondingly supporting the ST; and/or a MAC entity used in the DRB/LCH/HARQ correspondingly supporting the ST; and/or a carrier used in the DRB/LCH/HARQ correspondingly supporting the ST.

In some embodiments, in the case that the DRB/LCH/HARQ is configured with ST support or use, whether the DRB/LCH/HARQ is the HARQ-NACK, whether the HARQ-NACK is a consecutive HARQ-NACK, whether to enter the ST (state), whether to perform PDCP duplication activation, or whether transmission of the packet fails is determined by counting the HARQ-ACK and/or based on maintenance of a transmit (TX) side timer. In some embodiments, the determining method is based on at least one of the above methods. In some embodiments, the apparatus is applicable to the licensed band and the unlicensed band.

In some embodiments, in the case that the DRB/LCH/HARQ is configured with ST support or use, the processing module is configured to determine the ST state of the DRB/LCH/HARQ, or the processing module is configured to determine whether to trigger the DRB/LCH/HARQ to enter the ST state. In some embodiments, the processing module is configured as the MAC layer of the terminal. In some embodiments, the apparatus is applicable to the licensed band and the unlicensed band.

In some embodiments, in the case that the DRB/LCH/HARQ is configured with ST support or use, and the DRB/LCH/HARQ is not in the ST state, the processing module is configured to determine the ST state of the DRB/LCH/HARQ, or the processing module is configured to determine whether to trigger the DRB/LCH/HARQ to enter the ST state. In some embodiments, the processing module is configured as the MAC layer of the terminal. That is, detection/determination is not supported or performed in the case that the DRB/LCH/HARQ enters the ST state, or the detection/determination is performed in the case that the DRB/LCH/HARQ exits the ST state. In some embodiments, the apparatus is applicable to the licensed band and the unlicensed band.

In some embodiments, in the case that the DRB/LCH/HARQ is configured with ST support or use, the processing module is configured to determine exiting the ST state by at least one of the following conditions:
the ST timer is expired;
the network indicates exiting the ST state;
the network indicates PDCP duplication is deactivated, or PDCP duplication fails to enter the state prior to the ST;
the CGT is expired;
a HARQ-ACK indication or DFI-ACK indication is received prior to expiration of the CGRT;
the HARQ-ACK indication or DFI-ACK indication is received; or
furthermore, for example, in the ST state or prior to expiration of the ST timer, the HARQ-ACK indication or DFI-ACK indication is received, wherein the indication is for the ST state.

In some embodiments, the ST state is for at least one of: the DRB/LCH/HARQ correspondingly supporting the ST; and/or a HARQ process used in the DRB/LCH/HARQ correspondingly supporting the ST, and/or a CG or CG group used in the DRB/LCH/HARQ correspondingly supporting the ST, and/or DRB/LCH/HARQ correspondingly supporting the ST; and/or a MAC entity used in the DRB/LCH/HARQ correspondingly supporting the ST; and/or a carrier used in the DRB/LCH/HARQ correspondingly supporting the ST. In some embodiments, the apparatus is applicable to the licensed band and the unlicensed band.

In some embodiments, in the case that the DRB/LCH/HARQ is configured with ST support or use, the processing module is configured to determine the ST state of the DRB/LCH/HARQ, or the processing module is configured to determine whether to trigger the DRB/LCH/HARQ to enter the ST state. In some embodiments, the processing module is configured as the MAC layer of the terminal. In some embodiments, the apparatus is applicable to the licensed band and the unlicensed band.

In some embodiments, in the case that the DRB/LCH/HARQ is configured with ST support or use, counting of the HARQ-ACK and/or maintenance of the transmission (TX) side timer is for the DRB/LCH/HARQ correspondingly supporting the ST; and/or a HARQ process used in the DRB/LCH/HARQ correspondingly supporting the ST, and/or a CG or CG group used in the DRB/LCH/HARQ correspondingly supporting the ST, and/or DRB/LCH/HARQ correspondingly supporting the ST; and/or a MAC entity used in the DRB/LCH/HARQ correspondingly supporting the ST; and/or a carrier used in the DRB/LCH/HARQ correspondingly supporting the ST. In some embodiments, the apparatus is applicable to the licensed band and the unlicensed band.

The DRB/LCH/HARQ indicates a DRB or LCH or HARQ process.

In some embodiments, an implementation of combining the counting of the HARQ-ACK and the transmit (TX) side timer.
1) In S1, the network configures ST-related parameters for the DRB.

For example, the ST-related parameters include a TX side timer and a ST enabler. For simpleness, the network configures a 1:1 mapping for the DRB a specific CG, and the specific CG is associated with a HARQ process.
2) In S2, the MAC layer of the terminal determines to trigger the ST state of the DRB in the case that the DRB is not in the ST state. That is, the detection/determination is not supported in the case that the DRB enters the ST state, or the detection/determination is performed in the case that the DRB exits the ST state. The S2 is simultaneously applicable to the licensed band and the unlicensed band.

Specifically,
ST_COUNTER is a new variable for calculating consecutive HARQ-NACKs, and is initially set as 0 for the corresponding HARQ process or DRB;
the TX side timer is started or restarted for the corresponding HARQ or DRB process in the case that the initial transmission of a packet of the DRB is performed;
the ST_COUNTER of the corresponding HARQ process or DRB is plus 1 in the case that the TX side timer is running and receives the retransmission grant of the corresponding HARQ process or DRB;
the ST_COUNTER of the corresponding HARQ process or DRB is reset as 0 in the case that the TX side timer is running and receives the transmission grant of the corresponding HARQ process or DRB;
the ST_COUNTER of the corresponding HARQ process or DRB is reset as 0 and the upper layer is instructed to activate the PDCP duplication in the case that the ST_COUNTER is equal to N prior to expiration of the TX side timer; and
the ST_COUNTER of the corresponding HARQ process or DRB is reset as 0 in the case that the ST_COUNTER is less than N upon expiration of the TX side timer.
3) In S3, the PDCP of the terminal activates the PDCP duplication in response to PDCP duplication activation indication from the lower layer.

For the embodiments, in some embodiments, the DBR is replaced with the LCH.

For the embodiments, in some embodiments, the behaviors of the processing module are applicable to the licensed band and the unlicensed band.

In the R17 URLLC conflict resolution project, RAN1 supports the following conclusions regarding A/N feedback of SPS.

Deferral of SPS HARQ-ACK dropped due to time-division duplex (TDD) specific collision to a next available physical uplink control channel (PUCCH) is supported based on semi-persistent configuration of a slot format.

The DRX mechanism of the corresponding RAN2 is to be updated, that is, the drx-HARQ-RTT-TimerDL is started in the case that the UE is in the HARQ-ACK delay, such that the UE is in the on duration state in the DRX cycle, monitors a PDCCH, and acquires KL. K1 is used to carry parameters of PUCCH resources of the HARQ-ACK.

The embodiments of the present disclosure further provide a HARQ-ACK delay apparatus or an apparatus for starting a timer. The apparatus includes a processing module or a MAC module.

When DRX is configured, the processing module or the MAC module shall:
1. in the case that a MAC PDU is received in a configured downlink assignment: start the drx-HARQ-RTT-TimerDL for the corresponding HARQ process in the first symbol after the end of the corresponding transmission carrying the DL HARQ feedback; and stop the drx-RetransmissionTimerDL for the corresponding HARQ process; and
2. in the case that the HARQ-ACK is subject to HARQ-ACK deferral as specified in TS 38.213: start the drx-RetransmissionTimerDL in the first symbol upon the configured downlink assignment for the corresponding HARQ process.

FIG. 11 is a block diagram of a communication device (a terminal, a network device, or a network access device) according to some embodiments of the present disclosure. For example, the communication device is used to perform the above DRX configuration method. Specifically, the communication device 1100 includes: a processor 1101, a receiver 1102, a transmitter 1103, a memory 1104, and a bus 1105.

The processor 1101 includes one or more processing cores, and achieves various functional applications and information processing by running software programs and modules.

The receiver 1102 and the transmitter 1103 are practiced as a transceiver 1106, and the transceiver 1106 is a communication chip.

The memory 1104 is connected to the processor 1101 by the bus 1105.

The memory 1104 is configured to store one or more computer programs, and the processor 1101, when loading and running the one or more computer programs, is caused to perform the processes in the DRX configuration method performed by the terminal, the network device, or the network access device in the above method embodiments.

The transmitter 1103 is configured to perform processes related to transmission in the above method embodiments. The receiver 1102 is configured to perform processes related to reception in the above method embodiments. The processor 1101 is configured to perform processes other than processes related to transmission and reception in the above method embodiments.

In addition, the memory 1104 is achieved by any type of volatile or non-volatile storage device or combinations thereof. The volatile or non-volatile storage device includes, but is not limited to: a random-access memory (RAM), a read-only memory (ROM), an erasable programmable read-only memory (EPROM), an electrically erasable programmable read-only memory (EEPROM), a flash or other solid-state storage devices thereof, a compact disc read-only memory (CD-ROM), a digital video disc (DVD) or other optical storage devices, a cassette, a magnetic tape, a disk storage, or other magnetic storage devices.

In some embodiments, a network element device is further provided. The network element device includes: a processor and a memory storing one or more computer programs therein, wherein the processor, when loading and executing the one or more computer programs, is caused to perform the DRX configuration method, the method for entering the ST state based on HARQ-NACK, the HARQ-ACK delay method, or the method for starting the timer as described above.

In some embodiments, a terminal is further provided. The terminal includes: a processor and a memory storing one or more computer programs therein, wherein the processor, when loading and running the one or more computer programs, is caused to perform the DRX configuration method, the method for entering the ST state based on HARQ-NACK, the HARQ-ACK delay method, or the method for starting the timer as described above.

Some embodiments of the present disclosure further provide a computer-readable storage medium storing at least one instruction, at least one program, a code set, or an instruction set therein, wherein the at least one instruction, the at least one program, the code set, or the instruction set, when loaded and executed by a processor, cause the processor to perform the DRX configuration method, the method for entering the ST state based on HARQ-NACK, the HARQ-ACK delay method, or the method for starting the timer as described above.

Some embodiments of the present disclosure further provide a computer program product including one or more computer instructions therein. The one or more computer instructions are stored in a computer-readable storage medium, and when loaded and executed by a processor of a computer device, cause the computer device to perform the DRX configuration method or the method for entering the ST state based on HARQ-NACK as described above.

The above sequence numbers of embodiments in the present disclosure are only for description and do not represent the merits of embodiments.

It should be understood by persons of ordinary skill in the art that all or part of the processes in the above-mentioned embodiments may be implemented by hardware, or by a corresponding hardware instructed by a program. The program may be stored in a computer-readable storage medium, and the storage medium mentioned above may be a read-only memory, a magnetic disk, an optical disk, or the like.

Described above are merely exemplary embodiments of the present disclosure, and are not intended to limit the present disclosure. Any modifications, equivalent replacements, improvements and the like made within the spirit and principles of the present disclosure should be encompassed within the scope of protection of the present disclosure.

1. A discontinuous reception (DRX) configuration method, comprising:
receiving a specific DRX configuration, wherein the specific DRX configuration corresponds to a parameter configuration with a non-integer cycle.

2. The method according to claim 1, wherein the specific DRX configuration corresponds to a time jitter parameter configuration.

3. The method according to claim 1, wherein receiving the specific DRX configuration comprises:
receiving a plurality of sets of DRX configurations, wherein the plurality of sets of DRX configurations comprise the specific DRX configuration.

4. The method according to claim 3, wherein the plurality of sets of DRX configurations comprise:
indication information of the specific DRX configuration; or
type information of each of the plurality of sets of DRX configurations, wherein the type information comprises an integer cycle type or a non-integer cycle type.

5. The method according to claim 3, wherein the plurality of sets of DRX configurations belong to a same DRX group or different DRX groups.

6. The method according to claim 3, wherein each of the plurality of sets of DRX configurations comprises at least one of following parameters:
a DRX on duration timer (drx-onDurationTimer);
a DRX inactivity timer (drx-InactivityTimer);
a downlink DRX retransmission timer (drx-RetransmissionTimerDL);
an uplink DRX retransmission timer (drx-RetransmissionTimerUL); a long DRX cycle;
a short DRX cycle;
a long DRX cycle offset; or
a short DRX cycle offset.

7. The method according to claim 1, further comprising:
receiving a first medium access control (MAC) control element (CE), wherein the first MAC CE is a MAC CE used for the specific DRX configuration.

8. A terminal, comprising: a processor and a memory storing one or more computer programs therein, wherein the processor, when loading and running the one or more computer programs, is caused to:
receive a specific DRX configuration, wherein the specific DRX configuration corresponds to a parameter configuration with a non-integer cycle.

9. The terminal according to claim 8, wherein the specific DRX configuration corresponds to a time jitter parameter configuration.

10. The terminal according to claim 8, wherein the processor, when loading and running the one or more computer programs, is further caused to:
receive a plurality of sets of DRX configurations, wherein the plurality of sets of DRX configurations comprise the specific DRX configuration.

11. The terminal according to claim 10, wherein the plurality of sets of DRX configurations comprise:
indication information of the specific DRX configuration; or
type information of each of the plurality of sets of DRX configurations, wherein the type information comprises an integer cycle type or a non-integer cycle type.

12. The terminal according to claim 10, wherein the plurality of sets of DRX configurations belong to a same DRX group or different DRX groups.

13. The terminal according to claim 10, wherein each of the plurality of sets of DRX configurations comprises at least one of following parameters:
a DRX on duration timer (drx-onDurationTimer);
a DRX inactivity timer (drx-InactivityTimer);
a downlink DRX retransmission timer (drx-RetransmissionTimerDL);
an uplink DRX retransmission timer (drx-RetransmissionTimerUL);
a long DRX cycle;
a short DRX cycle;
a long DRX cycle offset; or
a short DRX cycle offset.

14. A network element device, comprising: a processor and a memory storing one or more computer programs therein, wherein the processor, when loading and running the one or more computer programs, is caused to:
transmit a specific DRX configuration, wherein the specific DRX configuration corresponds to a parameter configuration with a non-integer cycle.

15. The network element device according to claim 14, wherein the processor, when loading and running the one or more computer programs, is further caused to:
transmit a plurality of sets of DRX configurations, wherein the plurality of sets of DRX configurations comprise the specific DRX configuration.

16. The network element device according to claim 15, wherein the plurality of sets of DRX configurations comprise:
indication information of the specific DRX configuration; or
type information of each of the plurality of sets of DRX configurations, wherein the type information comprises an integer cycle type or a non-integer cycle type.

17. The network element device according to claim 15, wherein the plurality of sets of DRX configurations belong to a same DRX group or different DRX groups.

18. The network element device according to claim 15, wherein each of the plurality of sets of DRX configurations comprises at least one of following parameters:
a DRX on duration timer (drx-onDurationTimer);
a DRX inactivity timer (drx-InactivityTimer);
a downlink DRX retransmission timer (drx-RetransmissionTimerDL);
an uplink DRX retransmission timer (drx-RetransmissionTimerUL);
a long DRX cycle;
a short DRX cycle;
a long DRX cycle offset; or
a short DRX cycle offset.

19. The network element device according to claim 14, wherein the processor, when loading and running the one or more computer programs, is further caused to:
transmit a first medium access control (MAC) control element (CE), wherein the first MAC CE is a MAC CE used for the specific DRX configuration.

20. A non-transitory computer-readable storage medium, storing one or more computer programs therein, wherein the one or more computer programs, when loaded and run by a processor, cause the processor to perform the DRX configuration method as defined in claim 1.
